(19) United States
(12) Patent Application Publication
(10) Pub. No.: US 2022/0314401 A1
(43) Pub. Date: Oct. 6, 2022

(54) Aerial Lift Toolbox

(71) Applicant: Don Herrod, Sahuarita, AZ (US)

(72) Inventor: Don Herrod, Sahuarita, AZ (US)

(21) Appl. No.: 17/219,476

(22) Filed: Mar. 31, 2021

(51) Int. Cl. B25B 5/10; B25B 5/04; B25B 5/14; B25B 5/16

(52) U.S. Cl. CPC B25B 5/103; B25B 5/04; B25B 5/147; B25B 5/163

(57) ABSTRACT

The Trapdoor Clamp is the only product of its kind that allows individuals to safely place tools onto a highly adjustable platform to improve functionality of modern aerial lifts. The Trapdoor Clamp is uniquely designed with durable materials like rubber and metal to withstand force and ensure sustainability during operation. The clamp includes a channel having three sides defining open ends thereto, a trapdoor configured to create an open ended box with the three sided channel, a hinge configured to lengthwise join the trapdoor with the three sided channel, a trapdoor extension from the trapdoor, a stationary extension from the three sided channel configured to be in an opposing relation with the stationary extension and a fastener configured to put the trapdoor extension and the stationary extension in a compression.

### BACKGROUND

Boom, scissor, and articulating lifts are all regularly used in common construction and maintenance projects. Such equipment efficiency, however, is countered due to the lack of space to carry or hold other tools and materials that are needed to complete an operation. This in return creates an incredibly time consuming and frustrating situation for an individual and decreases productivity. There have been no products available as original equipment or as an aftermarket to address this problem.

An apparatus to simplify and enhance functionality and efficiency in construction and maintenance projects. There have been no products available as original equipment or as an aftermarket to address this problem either.

There exists a need for a device and a system such as the Trap Door Clamp Bracket, that is not being met by any known or disclosed device or system of present.

### SUMMARY OF THE INVENTION

The main purpose of Trapdoor Clamp is to enhance the functionality of an aerial lift by incorporating an adjustable tool tray. The Trapdoor Clamp ensures all needed tools are at a near proximity at all times to eliminate the hassle of users stopping operation to attain other objects.

The clamp includes a channel having three sides defining open ends thereto, a trapdoor configured to create an open ended box with the three sided channel, a hinge configured to lengthwise join the trapdoor with the three sided channel, a trapdoor extension from the trapdoor, a stationary extension from the three sided channel configured to be in an opposing relation with the stationary extension and a fastener configured to put the trapdoor extension and the stationary extension in a compression.

Embodiments include a crenelated bracket attached to an inside wall of the trapdoor and an opposing crenelated bracket attached to an inside wall of the channel. A piping within the clamp provides a stop to an inward swing of the trapdoor. An increase and a decrease in the compression is based on a respective decrease and increase in a length between the trapdoor extension and the stationary extension parallel to the fastener in operation therewith.

### BRIEF DESCRIPTION OF THE DRAWINGS

FIG. 1 This is a side perspective view of the Trapdoor Clamp apparatus in accordance with an embodiment of the present disclosure.

FIG. 2. This is a side perspective view of the Trapdoor Clamp apparatus with pipe accommodations in accordance with an embodiment of the present disclosure.

FIG. 3. This is a side perspective view of the Trapdoor Clamp apparatus with a pipe in accordance with an embodiment of the present disclosure.

FIG. 4. This is a side perspective view of the Trapdoor Clamp apparatus accommodating a tube in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The term ‘annularly’ used herein is taken from the common definition for annular meaning ring or circumscribing. The term ‘trapdoor,’ used throughout the disclosure defines a hinged or removable panel or part in a floor, ceiling or roof but more generally defines an access to some structure which in this case is an open ended box clamp.

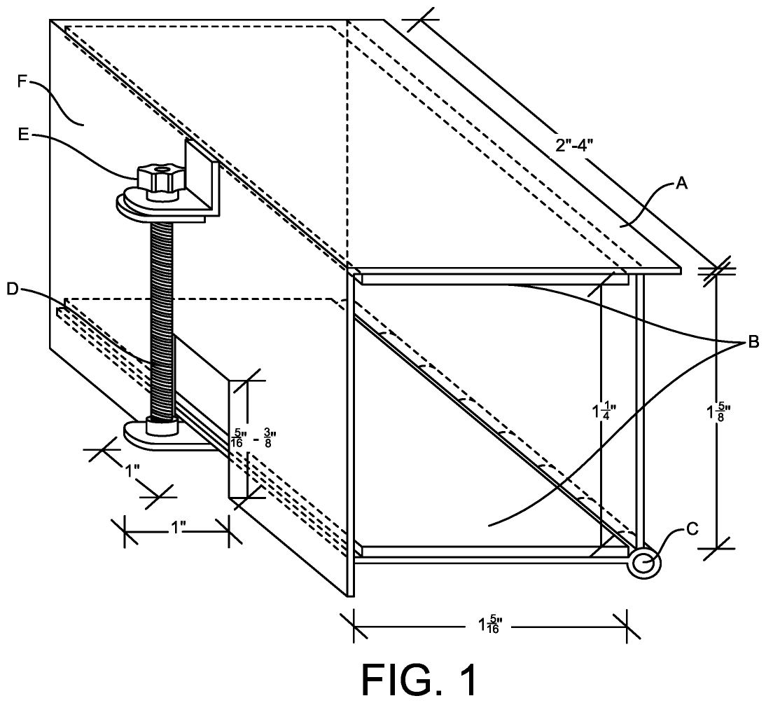

FIG. 1. This is a side perspective view of the Trapdoor Clamp apparatus showing: A. Metal plate, B. ⅛″ Rubber blocks with 1/16″ tape, C. Hinge, D. 5/16″-⅜″ Threaded knob, E. Tether, and F. Hinged box shackle in accordance with an embodiment of the present disclosure.

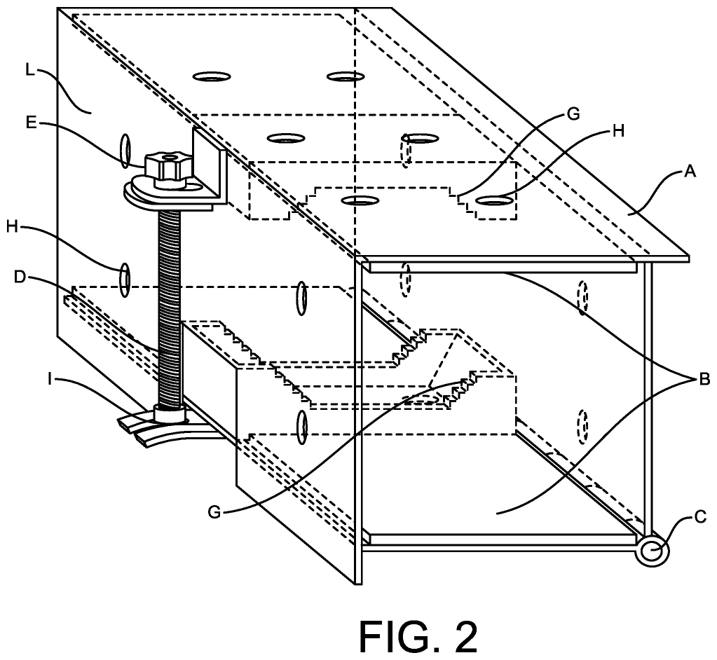

FIG. 2. This is a side perspective view of the Trapdoor Clamp apparatus with pipe accommodations showing: A. Metal plate, B. ⅛″ Rubber blocks with 1/16″ tape, C. Hinge, D. 5/16″-⅜″ Threaded knob, E. Tether, G. Insert for round steel tube, H. Holes for screws or nuts, I. Recessed hex or square to lock in place and L. metal plate in accordance with an embodiment of the present disclosure.

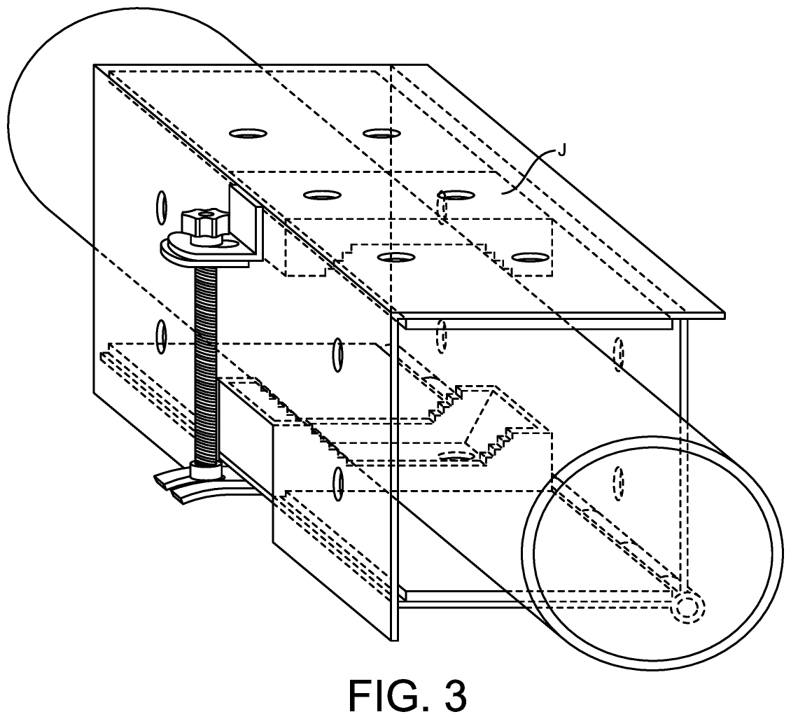

FIG. 3. This is a side perspective view of the Trapdoor Clamp apparatus accommodating a pipe showing: J. Attaches to square or round tubes, horizontally and vertically in accordance with an embodiment of the present disclosure.

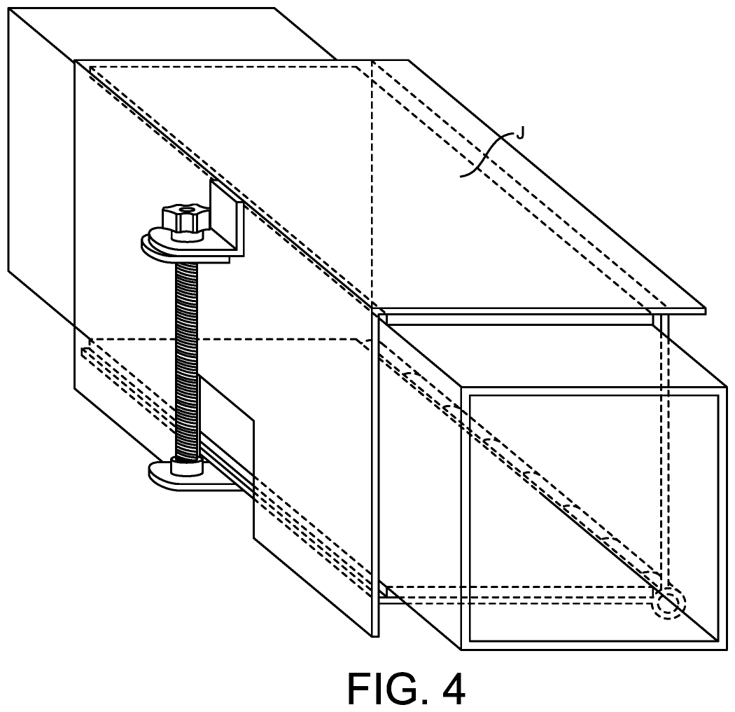

FIG. 4. This is a side perspective view of the Trapdoor Clamp apparatus accommodating a tube showing: J. Attaches to square or round tubes, horizontally and vertically in accordance with an embodiment of the present disclosure.

Expanding on the initial design of the modern aerial lift structure, this innovative product introduces a novel mounting clamp that attaches securely on to a lift and could be used with a variety of interchangeable attachments. The metal plate is located on the front surface of a hinged box shackle and is connected to a threaded knob, tether, and recessed hex to lock in place and guarantee a stable environment. Users would be able to place tools of any size onto the sturdy platform and increase the efficiency of the work being performed. Possessing strategically placed holes and compartments, this accessory effectively stores screws, nuts and other small equipment materials/tools while a large insert was curated to carry heavy round steel tubes, as needed. The Trapdoor Clamp ensures a fully operational tool space for multiple varieties of lifts and allows for smoother, non-stop operation on work sites.

Various brackets are attached to the clamp for shackling to other components not limited to seat belts, ski lifts, recreational vehicles, grocery cart retainers, animal care, sports and safety mechanisms and devices.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A clamp comprising:
a hinge configured to join a trapdoor side and a second side;
a third side joined to the second side and a fourth side joined to the third side, wherein one of the third side and the fourth side comprises a stationary extension;
a trapdoor extension from the trapdoor side configured to be in a compression relation with the stationary extension; and
a tether configured to put the first side in compression with an open ended box created by the trapdoor, the second, third and fourth sides via the trapdoor extension and the stationary extension.

2. The clamp of claim 1, wherein the trapdoor extension comprises a slot to receive the tether.

3. The clamp of claim 1, wherein the trapdoor extension defines an opening configured to annularly receive the tether.

4. The clamp of claim 1, wherein the tether is a threaded bolt.

5. The clamp of claim 1, wherein the trapdoor, the second, third and fourth sides define openings configured to receive screws, bolts and fasteners there through.

6. The clamp of claim 1, further comprising a crenelated bracket attached to an inside wall of the trapdoor and an opposing crenelated bracket attached to an inside wall of the third side.

7. The clamp of claim 1, wherein the trapdoor extension comprises a lip form drooping away from the compression with the stationary extension.

8. The clamp of claim 1, further comprising a threaded knob on the tether configured to fix a length between the trapdoor extension and the stationary extension.

9. The clamp of claim 1, further comprising a recess on the trapdoor extension configured to receive a bolt on the tether in a fixed relation to the trapdoor extension.

10. The clamp of claim 1, further comprising a rubber material on an inside surface of the clamp configured to inhibit an item in the clamp from moving therein.

11. The clamp of claim 1, wherein the stationary extension defines a slot defined therein to receive the tether.

12. The clamp of claim 1, wherein the stationary extension defines an opening defined to annularly receive the tether.

13. The clamp of claim 1, further comprising a retaining nut on the tether configured to keep a distance between the trapdoor extension and the stationary extension constant.

14. The clamp of claim 1, wherein a circular pipe in compression within the clamp provides a stop to an inward swinging motion of the trapdoor.

15. The clamp of claim 1, wherein a square pipe in compression within the clamp provides a stop to an inward swinging motion of the trapdoor.

16. A clamp comprising:
a channel having three sides defining open ends thereto;
a trapdoor configured to create an open ended box with the three sided channel;
a hinge configured to lengthwise join the trapdoor with the three sided channel;
a trapdoor extension from the trapdoor;
a stationary extension from the three sided channel configured to be in an opposing relation with the stationary extension; and
a fastener configured to put the trapdoor extension and the stationary extension in a compression.

17. The clamp of claim 16, further comprising a crenelated bracket attached to an inside wall of the trapdoor and an opposing crenelated bracket attached to an inside wall of the channel.

18. The clamp of claim 16, wherein a piping within the clamp provides a stop to an inward swing of the trapdoor.

19. The clamp of claim 16, wherein the trapdoor is configured to move on the hinge three hundred and sixty degrees.

20. The clamp of claim 16, further comprising an increase and a decrease in the compression based on a respective decrease and increase in a length between the trapdoor extension and the stationary extension parallel to the fastener in operation therewith.
